(19) United States
(12) Patent Application Publication
(10) Pub. No.: US 2010/0210357 A1
(43) Pub. Date: Aug. 19, 2010

(54) OVERLAY CONTENT IN A GAMING ENVIRONMENT

(76) Inventors: Kelly Slough, Northampton, MA (US); Steven Woods, Petersburg (CA); David Simons, Toronto (CA)

Correspondence Address: FOLEY & LARDNER LLP, 150 EAST GILMAN STREET, P.O. BOX 1497, MADISON, WI, 53701-1497, US

(21) Appl. No.: 12/388,079

(22) Filed: Feb. 18, 2009

(51) Int. Cl. A63F 13/00; A63F 9/24

(52) U.S. Cl. 463/30; 463/42; 463/43

(57) ABSTRACT

A method of overlaying content in a computer gaming environment includes loading a binary executable form of a computer program, analyzing graphical elements in the computer program while the computer program is in operation, receiving criteria to configure overlay content slots, and modifying an import address table of the binary executable form of the computer program such that logic for delivering overlay content is loaded when the computer program is in operation.

### FIELD

The subject of the disclosure relates generally to inserting content within a gaming environment. More specifically, the disclosure relates to overlay advertising and content display in a gaming environment.

### SUMMARY

An overlay or ticker advertisement is one in which a small graphical advertising element is displayed on top of the primary content being viewed. Overlay advertisements are commonly used in television broadcasts, often to display a station's logo unobtrusively in a corner of the screen, or to display reminders or promotions for upcoming shows in a portion of the screen while the current broadcast continues. Such overlay or ticker ads are used in online video on demand services where during playback of the video, a small overlay or ticker ad appears on a portion of the screen while the video continues. Overlay or ticker ads are considered desirable by some because early feedback suggests viewers find them less intrusive than more standard advertisements that interrupt a broadcast to deliver the advertisement.

Additional content may also be overlaid on top of the primary content being viewed. In addition to advertisements, the overlay content may include player progress indicators, status updates for rival players, or indicators that rival players are online. Such overlay content is desirable because it may enhance a player's enjoyment of the game by introducing goals, benchmarks, and competitors to the game experience.

A representative embodiment includes a mechanism and process by which overlay content or ticker advertisements or branding elements can be automatically added to a computer video game without requiring any access or changes to source code for the game. The graphical element may be a static image, an animation involving movement, rotation, scaling, fading in or out of a static image, or an animation sequence involving multiple frames. The overlay content is delivered in such a way that it does not negatively intrude in the game playing experience and does not require game play to stop while the ad is visible. This can require variously that the overlay content be delivered with a degree of transparency, with specific conditions associated with its location, including automatically disappearing, moving or shrinking in response to actions taken in the game.

In a first representative embodiment, a method of overlaying content in a computer gaming environment includes loading a binary executable form of a computer program, analyzing graphical elements in the computer program while the computer program is in operation, receiving criteria to configure overlay content slots, and modifying an import address table of the binary executable form of the computer program such that logic for delivering overlay content is loaded when the computer program is in operation.

In a second representative embodiment, a device for overlaying content in a computer gaming environment includes an application with computer code that loads a binary executable form of a computer program, defines a graphical element from the computer program in response to a first user input, receives criteria to configure overlay content slots, and modifies an import address table of the binary executable based on the received criteria so that logic for delivering overlay content is loaded when the computer program is in operation. The device further includes a memory that stores the application and a processor coupled to the memory that executes the application.

In a third representative embodiment, a method of overlaying content in a computer gaming environment includes intercepting a call from a computer program to a graphics library while the computer program is in operation, wherein the call defines a request to render a graphical element of the computer program, and rendering an overlay content within the game that is associated with the graphical element of the computer program.

Other principal features and advantages will become apparent to those skilled in the art upon review of the following drawings, the detailed description, and the appended claims.

### BRIEF DESCRIPTION OF THE DRAWINGS

Representative embodiments will hereafter be described with reference to the accompanying drawings.

FIG. 1 is a flow diagram illustrating operations performed by a content addition software system in accordance with a representative embodiment.

FIG. 2 is a graphical user interface (GUI) of a tool software program for overlaying content in a computer program.

FIG. 3 is a GUI of a tool software program for modifying overlaid content in a computer program.

FIG. 4 is a block diagram illustrating a content addition software system in accordance with a representative embodiment.

FIG. 5 is an illustration of full-size overlaid content within a computer program.

FIG. 6 is an illustration of partially shrunk overlaid content within a computer program.

FIG. 7 is an illustration of fully shrunk overlaid content within a computer program.

### DETAILED DESCRIPTION

The online video game industry typically follows a model whereby an online video game is developed at a small game studio which then licenses the game to various publishers and distributors who in turn make the game available to the end user. The game studio delivers the game to the publisher in a binary executable format without any of the source code or associated data.

It is desirable for many publishers to derive revenue from the game by delivering content such as advertisements during game play. However, without access to the source code, it is not possible for publishers to modify games to incorporate specialized advertising logic in a separate library that must be linked into the game. A representative embodiment allows overlay and ticker content and advertising to be incorporated into a game without requiring any access to the source code. Another representative embodiment includes tools and a process by which the logic required to deliver overlay content and advertisements is melded into the game's binary files and secured against tampering. Yet another representative embodiment allows games to be enabled for overlay content and advertisements in the post-production or post-release phase of the game's life cycle.

A sample computer video game demonstrates capabilities of the representative embodiment. The standard binary executable form of the game is obtained from the game publisher. It is identical to the version that a consumer receives with the exception that the game files a consumer receives have been protected by digital rights management (DRM) software. The process for preparing the game for overlay content is performed by a content enablement technician using a content addition software system.

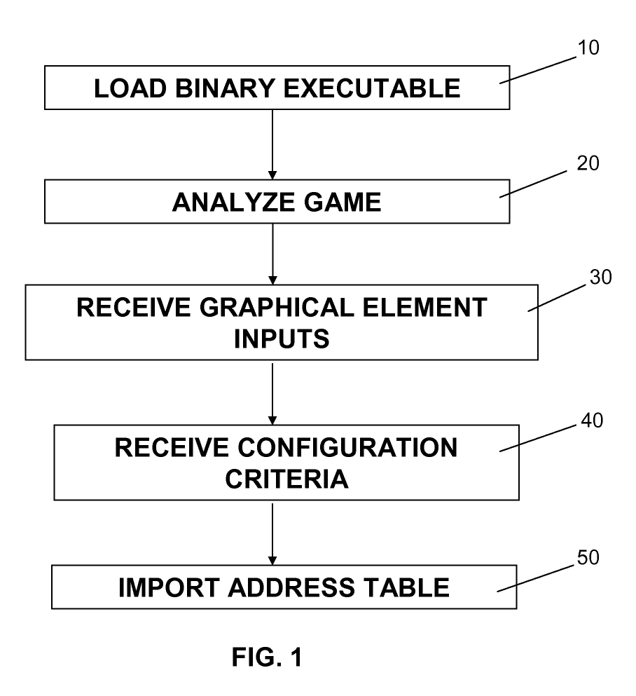

FIG. 1 illustrates a flow diagram of operations performed in the addition of overlay content to an executable computer program, such as a computer game. Additional, fewer, or different operations may be performed depending on the particular implementation. In an operation 10, a standard binary executable form of a computer program, such as a computer game, is loaded for analysis by a custom tool software program. In an operation 20, the custom tool software program analyzes the game to determine if the game can be content-enabled. As such, the game is analyzed to determine if content- or ad-enablement services can be injected into the game and to identify the core video and audio technologies used to build the game. The analysis includes examination of the game executable itself (including any available version or file identification information), as well as running the game to examine the external libraries used during game play (such as DirectX). Additional or less information about the game may be analyzed according to various embodiments.

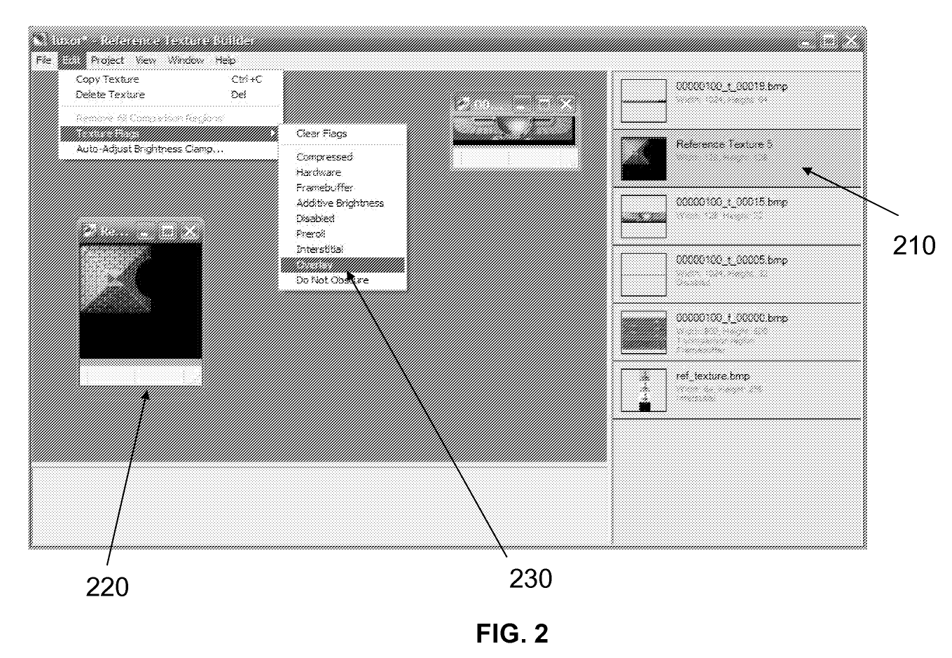

In an operation 30, the custom tool software program receives inputs identifying graphical elements in a game while the game is played. The custom tool software program receives inputs from the content enablement technician. The content enablement technician identifies unique textures and elements of frame buffers and enters inputs signifying these textures and elements into the custom tool software program. The custom tool software program receives the inputs from the content enablement technician and defines graphical elements within the game where overlay content may be displayed. FIG. 2 illustrates an exemplary embodiment of a graphical user interface (GUI) of the custom tool software program. Display box 210 represents the identified graphical element 220. These graphical elements are passed from the game to a graphics rendering engine during the construction of each frame of the game. Each of these graphical elements is captured and displayed for a content enablement technician to use in the subsequent operations of the content and ad enablement process.

In an operation 40 of FIG. 1, the tool software program receives criteria definitions to configure overlay content slots. One criteria definition can include the presence or absence of a particular graphical element in a frame as a trigger to display an overlay content such as an overlay advertisement. Graphical element 220 of FIG. 2 is used as a trigger to display the overlay content. The tool software program receives an input to define the graphical element 220 as a trigger. This definition of the graphical element 220 as a trigger corresponds to a selection of an overlay input 230 by the content enablement technician from a menu of the tool software program. Another criteria definition can be time intervals in combination with the presence or absence of particular graphical elements, or time intervals alone. Different classes of overlay content slots can be configured independently. For example, an overlay content slot displaying a simple branding element such as a small logo may be configured to appear more frequently than an overlay content slot that features a larger advertisement with a user call to action.

In addition, overlay content may include indicators of player progress, indicators of rival player progress, status updates about challenges in which a player is involved, and indicators that a rival player is online. A person of skill in the art will recognize that these indicators are not limiting and that any kind of content may be overlaid on the primary content of a computer program according to various embodiments. The content used to generate these content overlays may also be gathered from the running computer programs and compiled. This compiled content may be used generate leader boards, achievements, and player networks.

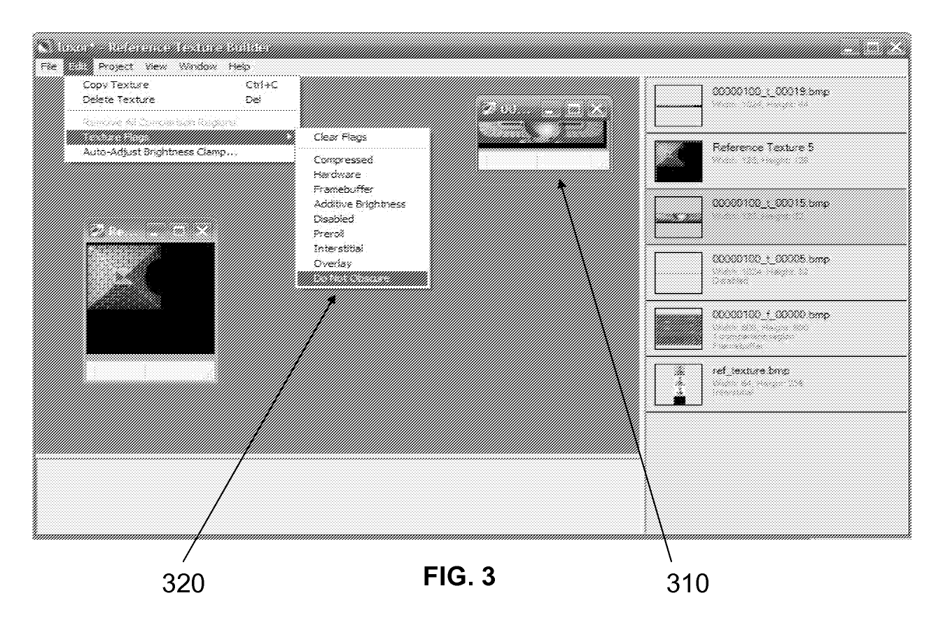

Optionally, FIG. 3 illustrates an embodiment of a GUI of the tool software program in which one or more graphical elements rendered in the game can be identified as being “non-overlayable”. These may be graphical elements that are rendered in a fixed location within the game, or may move within the game. Any graphical element identified by the technician as “non-overlayable” is never obscured by an overlay content while the game is being played. The tool software program receives an input 320 which defines a graphical element 310 as a “non-overlayable” element.

In an operation 50 of FIG. 1, an import address table of the game's main binary executable file (i.e., the EXE file) is modified such that when the game is run, it automatically loads the logic responsible for delivering overlay content and verifies the overlay content logic has not been tampered with.

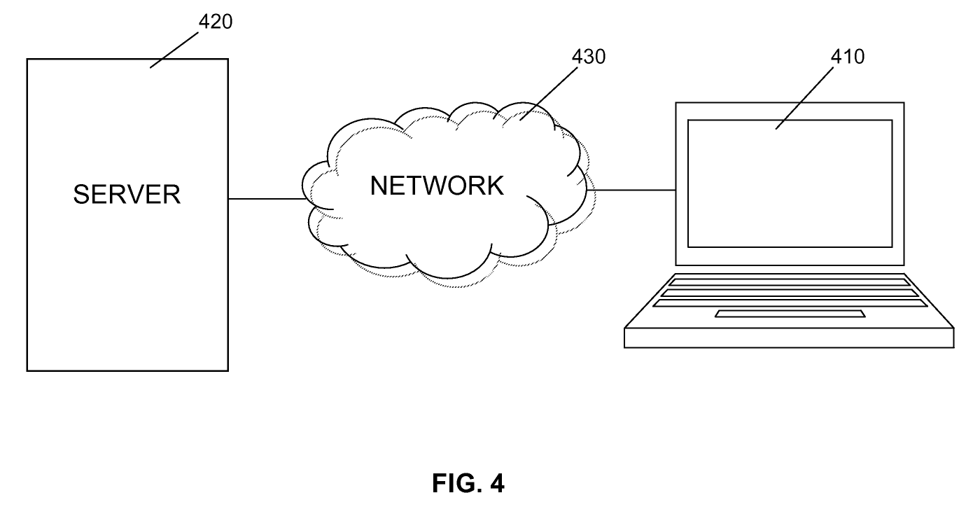

FIG. 4 illustrates a content addition software system 400. The system 400 includes a client computer 410, a central server 420, and a network 430. When an overlay content-enabled game is run on the client computer 410, software in the game added during the overlay content enablement process loads and verifies overlay content logic. The overlay content logic coordinates with the central server 420 to determine the content policy currently defined for the particular game. The content policy can contain updates to the overlay content slot criteria defined by the content enablement technician in operation 40 of the content enablement process described with reference to FIG. 1.

While the game is played on the client computer 410, the overlay content logic intercepts and inspects specific calls from the game logic to the underlying graphics libraries. In particular, the overlay content logic marks the beginning and ending of each frame rendered in the game, and within each frame watches for calls to the graphics libraries that render any of the graphical elements defined as either: triggers for beginning an overlay content or “non-overlayable” graphical elements. In any frame in which an overlay content is being displayed, after the game has completed its rendering for the frame, the overlay content logic completes its rendering of the current frame of the overlay content. This rendering includes applying any transparency, scaling, rotation and proper positioning of the overlay content elements. If a “non-overlayable” graphical element was rendered by the game in the current frame, its exact coordinates are determined and a calculation is made as to whether any portion of the overlay content would obscure the non-overlayable graphical element. If rendering of the overlay content would obscure any part of the non-overlayable graphical element, then an action is taken to alter the rendering of the overlay content.

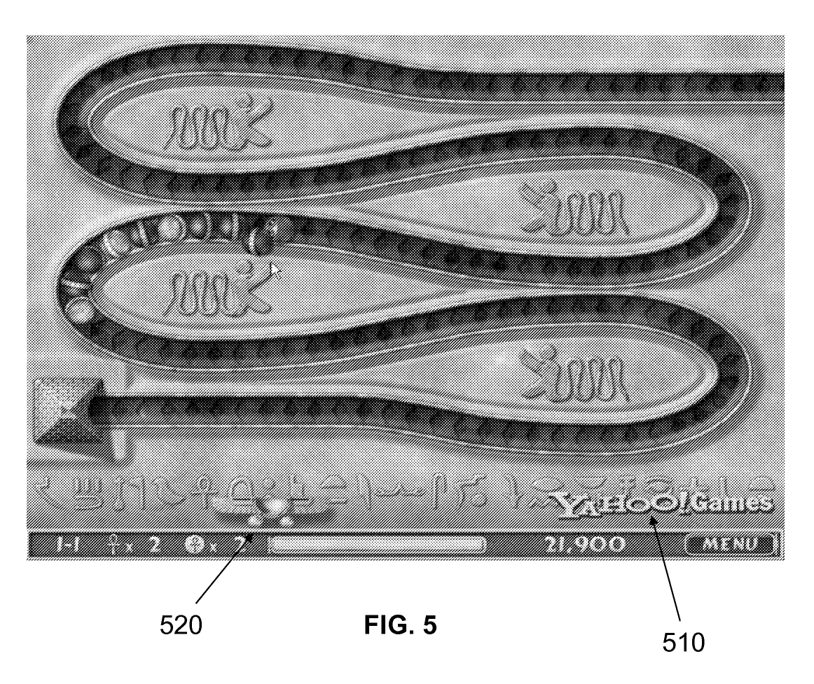

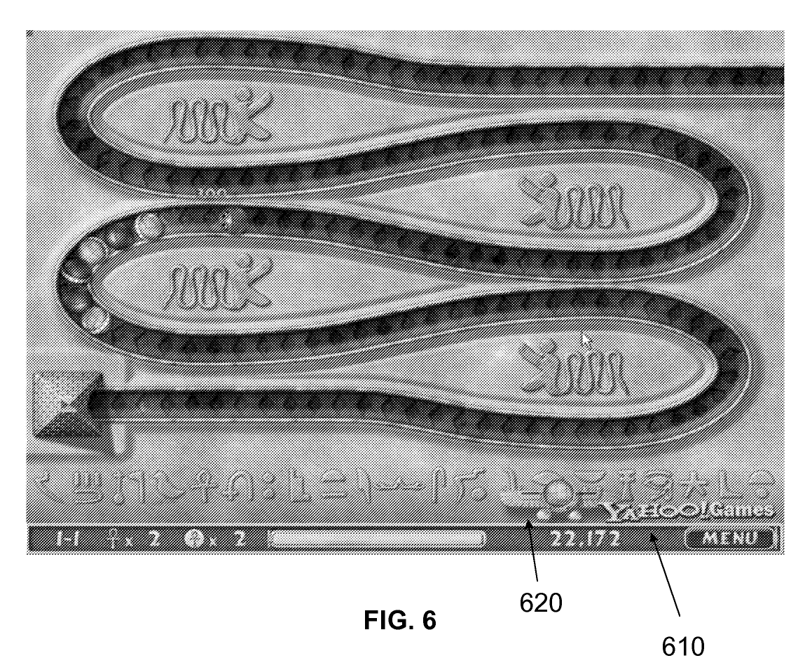

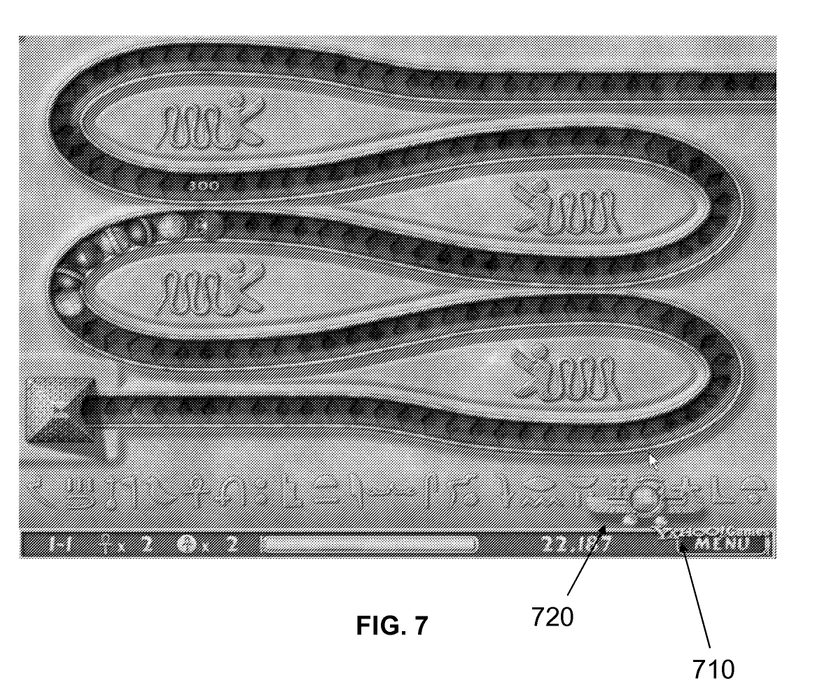

In the situation where rendering of the overlay content would obscure any part of the non-overlayable graphical element, the actions that the overlay content may take include: (1) shrinking in size until it no longer obscures the non-overlayable graphical element, (2) becoming fully transparent in the portion that overlaps the non-overlayable graphical element, or (3) minimizing itself to a location on the game screen that does not obscure the non-overlayable graphical element. FIGS. 5, 6, and 7 are representations of a GUI of a running software game during gameplay. FIG. 5 illustrates a full size overlay content 510 and a non-overlayable graphical element 520. FIG. 6 illustrates an overlay content 610 that has partially shrunk in response to its obscuring of a non-overlayable graphical element 620. FIG. 7 illustrates an overlay content 710 that has been fully shrunk in response to its obscuring of a non-overlayable graphical element 720.

An overlay content can be configured to allow the user the option to minimize or fully close the overlay content, either temporarily or for the duration of the gaming session. Minimizing the overlay content involves reducing in size the overlay content to a small iconic representation that features buttons to restore or fully hide the overlay content.

An overlay content can be configured to be clickable with any clicks by the user on the overlay resulting in a network request to the central server 420 that is counted and tracked. The result of the click can be to display online content in a web browser window external to the game, while the game is paused and minimized, or to display online or local content in a web browser window rendered within the game environment while the game remains paused but visible around the perimeter of the web browser window.

A large variety of overlay content creatives can be delivered using the representative embodiments described herein. The content graphical element may be a static image, an animation involving movement, rotation, scaling, fading in or out of a static image, or an animation sequence involving multiple frames. It is possible to define various parameters that control when and where during game play that the overlay content appears. It is also possible to define some elements of the game play scene to be “critical” for the user to be able to see and have the overlay content scale its dimensions such that it does not obscure the critical game element.

In a representative embodiment, user interactions with the overlay content are tracked, including all mouse interactions with the overlay content. Actions can be defined to occur when mouse clicks occur within specific regions of the overlay content, including the ability to display web content in a web browser window that is fully integrated into the game window, or alternatively to display web content in a separate web browser window and process on the user's computer. The configuration of the overlay content or advertisement campaign is done centrally so that fine-grained control over the timing and number of content or advertisement impressions delivered is possible.

The foregoing description has been presented for purposes of illustration and of description. It is not intended to be exhaustive or limiting with respect to the precise form disclosed, and modifications and variations are possible in light of the above teachings or may be acquired from practice of the disclosed embodiments.

What is claimed is:

1. A method of overlaying content in a computer gaming environment, the method comprising:
loading a binary executable form of a computer program;
receiving an input while the computer program is in operation, wherein the input identifies a graphical element in the computer program;
receiving criteria to configure overlay content slots; and
modifying an import address table of the binary executable form of the computer program based on the received criteria such that logic for delivering overlay content is loaded when the computer program is in operation.

2. The method of claim 1, wherein the overlay content comprises an overlay advertisement.

3. The method of claim 1, wherein the computer program includes a software game.

4. The method of claim 1, wherein the criteria to configure overlay content slots includes presence of a graphical element in a frame of the computer program as a trigger for the overlay content.

5. The method of claim 1, wherein the criteria to configure overlay content slots includes time intervals.

6. The method of claim 1, wherein the criteria to configure overlay content slots includes identification of a graphical element in a frame of the computer program as non-overlayable.

7. The method of claim 1, wherein overlay content is located in a separate database accessed when the computer program is in operation.

8. The method of claim 1, further comprising analyzing the computer program to determine if the computer program may be content-enabled.

9. A device for overlaying content within a computer program, the device comprising:
an application, the application comprising computer code configured to:
load a binary executable form of a computer program,
while the computer program is in operation, define a graphical element from the computer program in response to a first user input,
receive criteria to configure overlay content slots, and
modify an import address table of the binary executable form of the computer program based on the received criteria such that logic for delivering overlay content is loaded when the computer program is in operation;
a memory, wherein the memory is configured to store the application; and
a processor, wherein the processor is coupled to the memory and configured to execute the application.

10. The device of claim 9, wherein the overlay content comprises an overlay advertisement.

11. The device of claim 9, wherein the computer program includes a software game.

12. The device of claim 9, wherein the computer code is further configured to analyze the computer program to determine if the computer program may be content-enabled.

13. The device of claim 9, wherein the criteria to configure overlay content slots includes presence of a graphical element in a frame of the computer program as a trigger for an overlay content.

14. The device of claim 9, wherein the criteria to configure overlay content slots includes time intervals.

15. The device of claim 9, wherein the criteria to configure overlay content slots includes identification of a graphical element in a frame of the computer program as non-overlayable.

16. The device of claim 9, wherein overlay content is located in a separate database accessed when the computer program is in operation.

17. A computer-readable medium having computer-readable instructions stored thereon, which when executed by a processor, cause a computing device to:
load a binary executable form of a computer program;
receive an input while the computer program is in operation, wherein the input identifies a graphical element in the computer program;
receive criteria to configure overlay content slots; and
modify an import address table of the binary executable form of the computer program based on the received criteria such that logic for delivering overlay content is loaded when the computer program is in operation.

18. The computer-readable medium of claim 17, wherein the overlay content comprises an overlay advertisement.

19. The computer-readable medium of claim 17, wherein the computer program includes a software game.

20. The computer-readable medium of claim 17, wherein the computer-readable instructions further cause a computing device to analyze the computer program to determine if the computer program may be content-enabled.

21. The computer-readable medium of claim 17, wherein the criteria to configure overlay content slots includes presence of a graphical element in a frame of the computer program as a trigger for an overlay content.

22. The computer-readable medium of claim 17, wherein the criteria to configure overlay content slots includes time intervals.

23. The computer-readable medium of claim 17, wherein the criteria to configure overlay content slots includes identification of a graphical element in a frame of the computer program as non-overlayable.

24. The computer-readable medium of claim 17, wherein overlay content is located in a separate database accessed when the computer program is in operation.

25. A method of overlaying content in a computer gaming environment, the method comprising:
intercepting a call from a computer program to a graphics library while the computer program is in operation, wherein the call defines a request to render a graphical element of the computer program; and
rendering an overlay content within the game, wherein the overlay content is associated with the graphical element of the computer program.

26. The method of claim 25, wherein the graphical elements is a non-overlayable graphical element.

27. The method of claim 26, further comprising modifying the overlay content if at least a portion of the rendered overlay content would obscure the non-overlayable graphical element.

28. The method of claim 27, further comprising determining coordinates of the non-overlayable graphical element and calculating whether at least a portion of the rendered overlay content obscures the non-overlayable graphical element.

29. The method of claim 28, wherein the modifying comprises shrinking the overlay content.

30. The method of claim 28, wherein the modifying comprises making the overlay content transparent.

31. The method of claim 28, wherein the modifying comprises minimizing the overlay content.

32. The method of claim 25, wherein the overlay content is configured to minimize or close in response to a user input.

33. The method of claim 25, further comprising tracking user selections of the overlay content.

34. The method of claim 25, further comprising displaying content in response to a user selection of the overlay content.
